(19) United States
(12) Patent Application Publication
(10) Pub. No.: US 2026/0129414 A1
(43) Pub. Date: May 7, 2026

(54) SYSTEM

(71) Applicant: TOYOTA JIDOSHA KABUSHIKI KAISHA, Toyota-shi (JP)

(72) Inventor: Takamasa Higuchi, Tokyo (JP)

(73) Assignee: TOYOTA JIDOSHA KABUSHIKI KAISHA, Toyota-shi (JP)

(21) Appl. No.: 19/244,521

(22) Filed: Jun. 20, 2025

(30) Foreign Application Priority Data
Nov. 1, 2024 (JP) 2024-192702

(51) Int. Cl. H04W 4/46; H04W 4/024; H04W 24/08

(52) U.S. Cl. CPC H04W 4/46; H04W 4/024; H04W 24/08

(57) ABSTRACT

The system includes a database in which communication performance data on a communication quality of a vehicle is stored, a route specifying unit configured to specify one route of which communication performance data within a predetermined period is not acquired, a vehicle specifying unit configured to specify one vehicle including the one route as a scheduled travel route, and an acquisition unit configured to acquire one piece of communication performance data from one vehicle traveling on the one route.

### CROSS-REFERENCE TO RELATED APPLICATION

This application claims priority to Japanese Patent Application No. 2024-192702 filed on Nov. 1, 2024. The disclosure of the above-identified application, including the specification, drawings, and claims, is incorporated by reference herein in its entirety.

### BACKGROUND

### 1. Technical Field

The present disclosure relates to a technical field of a system related to communication.

### 2. Description of Related Art

As this kind of system, for example, a system that provides route information indicating a route for a moving body that autonomously moves to reach a destination has been proposed. A system in which a route is searched according to a cost related to a wireless communication quality has been proposed (see Japanese Unexamined Patent Application Publication No. 2022-072934 (JP 2022-072934 A)).

### SUMMARY

In a case where the moving body moves from a cell of one wireless base station to a cell of another wireless base station, the communication quality may deteriorate. In a technique described in JP 2022-072934 A, in a case where communication between a mobile robot as the moving body and a navigation device is interrupted, the mobile robot may autonomously return to a place where the communication with the navigation device is restored. However, such a response is not suitable for a moving body occupied by a person, such as an autonomous driving vehicle.

The present disclosure can provide a system capable of collecting data for predicting a communication quality.

A system according to an aspect of the present disclosure includes:

a database in which communication performance data related to a communication quality of a vehicle is stored;
a route specifying unit configured to specify one route for which communication performance data within a predetermined period has not been acquired;
a vehicle specifying unit configured to specify one vehicle having a scheduled travel route that includes the one route; and
an acquisition unit configured to acquire one piece of communication performance data from the one vehicle that travels on the one route.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a configuration of a system according to an embodiment; and

FIG. 2 is a block diagram showing an example of a configuration of a system according to a modification of the embodiment.

### DETAILED DESCRIPTION OF EMBODIMENTS

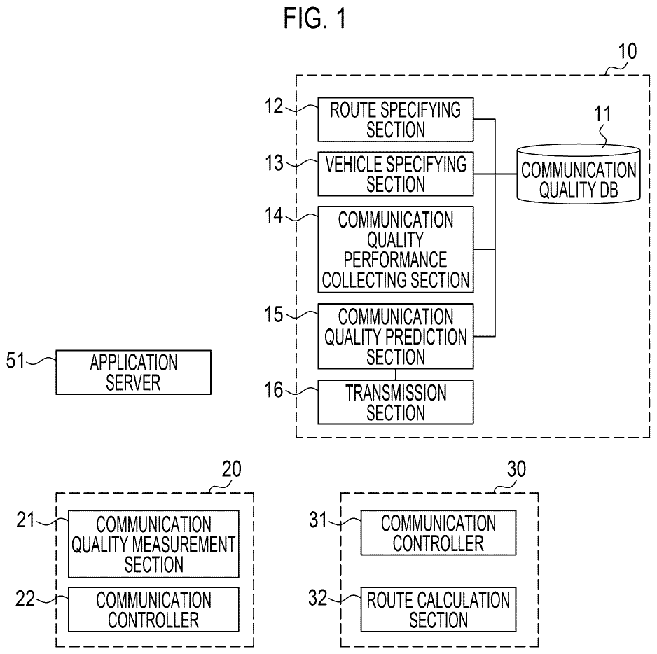

An embodiment relating to the system will be described with reference to FIG. 1. Hereinafter, an embodiment of the system will be described using the prediction server 10 as an example of the system.

In FIG. 1, the prediction server 10 includes a communication quality database 11, a route specifying section 12, a vehicle specifying section 13, a communication quality performance collecting section 14, a communication quality prediction section 15, and a transmission section 16. The prediction server 10 is configured to communicate with the vehicles 20, 30. In the present embodiment, the vehicle 30 is an autonomous driving vehicle that autonomously travels by the autonomous driving function. In the present embodiment, the prediction server 10 predicts the communication quality on the scheduled traveling route of the vehicle 30. The vehicle 20 may be a vehicle that is driven by a person. The vehicle 20 may have an autonomous driving function. The vehicles 20, 30 may be connected cars.

The communication quality performance collecting section 14 collects the communication quality data from one or more vehicles (for example, the vehicle 20). The communication quality data may be data indicating communication quality between the vehicle and a network node other than the vehicle. For example, the network node other than the vehicle may include at least one of the communication base station and the application server 51. The communication quality data may include a communication log regarding communication between the vehicle and the network node.

Here, the vehicle 20 will be described. The vehicle 20 includes a communication quality measurement section 21 and a communication controller 22. The communication controller 22 controls transmission and reception of communication data between the vehicle 20 and a network node other than the vehicle 20 (for example, at least one of the communication base station and the application server 51). The communication quality measurement section 21 measures the communication quality of the vehicle 20. For example, the communication quality may include first information passively obtained by monitoring a signal from a wireless channel or a wireless communication base station and second information obtained by performing data communication with a server, such as the application server 51. The first information may include at least one of received power, an S/N ratio, a channel use rate, and the number of communication base stations within a communication range. The second information may include at least one of a communication delay, a throughput, and an application-level service quality. The throughput may mean the amount of data transmitted and received per unit time. The communication quality measurement section 21 produces communication quality data including the measured communication quality and vehicle information related to the vehicle 20. The communication quality measurement section 21 transmits the produced communication quality data to the prediction server 10. The communication quality data is an example of the communication quality data collected by the communication quality performance collecting section 14.

The communication quality performance collecting section 14 of the prediction server 10 performs a predetermined aggregation process on the collected communication quality data, and stores the communication quality data in the communication quality database 11. As the predetermined aggregation processing, processing of grouping the collected communication quality data according to a predetermined condition is performed.

The communication quality prediction section 15 predicts the communication quality (for example, the communication quality after several seconds to several minutes) on the scheduled traveling route of the vehicle 30 based on the communication quality data stored in the communication quality database 11. In a case where the vehicle 30 has a plurality of communication units, the communication quality prediction section 15 may predict the communication quality for each communication unit. For example, the communication means may include at least two of cellular communication, Wi-Fi (registered trademark) communication, and satellite communication. The transmission section 16 transmits the communication quality predicted by the communication quality prediction section 15 to the vehicle 30.

Here, the vehicle 30 will be described. The vehicle 30 includes a communication controller 31 and a route calculation section 32. The communication controller 31 controls the communication of the vehicle 30. For example, the communication controller 31 may control a compression rate of data related to communication, a communication interface to be used, and the like. The communication controller 31 may send a query to the prediction server 10 about the predicted value of the communication quality of the communication unit on the scheduled travel route of the vehicle 30. The communication quality prediction section 15 of the prediction server 10 may predict the communication quality under the condition that the inquiry is made from the communication controller 31 of the vehicle 30. The communication controller 31 may control the communication of the vehicle 30 based on the predicted value of the communication quality. For example, in a road section where a decrease in communication quality is predicted, the communication controller 31 may increase a compression rate of data in advance or preferentially use a communication method having higher performance. The route calculation section 32 calculates a route of the vehicle 30. For example, the route calculation section 32 may calculate the route of the vehicle 30 while the road section where the decrease in the communication quality is predicted is avoided. With the configuration as described above, it is possible to reduce the decrease in the communication quality during traveling of the vehicle 30.

For example, the communication quality prediction section 15 of the prediction server 10 may predict the communication quality by regression analysis based on the communication quality data stored in the communication quality database 11. By the way, the communication quality varies depending on the day even in the same place and at the same time. Therefore, with solely the regression analysis based on the past period (for example, several days to several tens of days), the precision of the predicted communication quality is not sufficient. Therefore, the communication quality prediction section 15 may correct the communication quality predicted by the regression analysis based on the communication quality data within a predetermined period from the current time (for example, several minutes to several tens of minutes ago). With the configuration as described above, the precision of the predicted communication quality can be improved.

As described above, the communication quality may include the first information and the second information. In order to obtain the second information, data communication with the server is needed. Within the predetermined period, the communication quality data that can be used for the correction cannot be obtained from the road section (in other words, the link) in which the vehicle that performs the data communication with the server is not present.

Therefore, the route specifying section 12 of the prediction server 10 refers to the communication quality data stored in the communication quality database 11 to specify the route (in other words, the road section) for which the communication quality data within the predetermined period is not obtained. For example, the route specifying section 12 may specify one route as a route for which the communication quality data within the predetermined period is not obtained. In this case, the vehicle specifying section 13 specifies one vehicle including one route in the scheduled travel route among a plurality of vehicles (for example, the vehicle 20) of which the prediction server 10 can acquire the communication quality data.

For example, the communication quality performance collecting section 14 may transmit the unacquired-link information indicating one route for which the communication quality data within the predetermined period is not obtained to the specified one vehicle. Here, the description will be continued on the assumption that the specified one vehicle is the vehicle 20. When the vehicle 20 enters one route indicated by the unacquired-link information, the communication controller 22 of the vehicle 20 may control the communication device (not shown) to perform data communication with the server (for example, the application server 51). The communication quality measurement section 21 may measure the communication quality while the data communication is being performed. As a result, the communication quality performance collecting section 14 of the prediction server 10 can acquire the communication quality data within the predetermined period for the one route.

In a case where the vehicle 20 performs the data communication in response to the unacquired-link information, the data communication may be performed by using dummy data. However, in this case, a communication overhead may be a problem. Therefore, the vehicle 20 may receive the unacquired-link information. In this case, the communication controller 22 may temporarily (for example, several tens of seconds to several minutes) delay the execution of at least one of the download of the data without immediacy from the application server (for example, the application server 51) and the upload of the data without immediacy to the application server. When the vehicle 20 enters one route indicated by the unacquired-link information, the communication controller 22 may control the communication device to perform at least one of downloading and uploading the delayed data. With the configuration as described above, it is possible to reduce communication overhead caused by measuring communication quality.

The route specifying section 12, the vehicle specifying section 13, and the communication quality performance collecting section 14 may be integrally configured. For example, the communication quality performance collecting section 14 may have a function of each of the route specifying section 12 and the vehicle specifying section 13. Note that a part of the processing executed by at least one of the communication controller 31 and the route calculation section 32 of the vehicle 30 may be executed by the prediction server 10. For example, the route calculation of the vehicle 30 considering the communication quality may be performed by the prediction server 10. The vehicle 30 may include a communication quality measurement section corresponding to the communication quality measurement section 21 of the vehicle 20. In this case, the vehicle 30 may transmit the communication quality data to the prediction server 10.

### Technical Effect

The communication quality prediction section 15 of the prediction server 10 may correct the communication quality predicted by the regression analysis based on the communication quality data within a predetermined period from the current time (for example, from several minutes to several tens of minutes ago, in other words, the most recent). With the configuration as described above, it is possible to improve the prediction precision of the communication quality. For example, the route calculation section 32 of the vehicle 30 calculates the route of the vehicle 30 based on the communication quality predicted by the communication quality prediction section 15, whereby it is possible to reduce an unexpected decrease in the communication quality of the vehicle 30.

The communication quality performance collecting section 14 of the prediction server 10 can acquire (in other words, collect) the communication quality data of the road section without the latest communication quality data from the vehicle by transmitting the unacquired-link information to the vehicle (for example, the vehicle 20). That is, the prediction server 10 can collect the data for predicting the communication quality. For example, when the vehicle 20 enters one route indicated by the unacquired-link information, the vehicle 20 can reduce the communication overhead due to the measurement of the communication quality by performing the data communication for measuring the communication quality.

### Modification

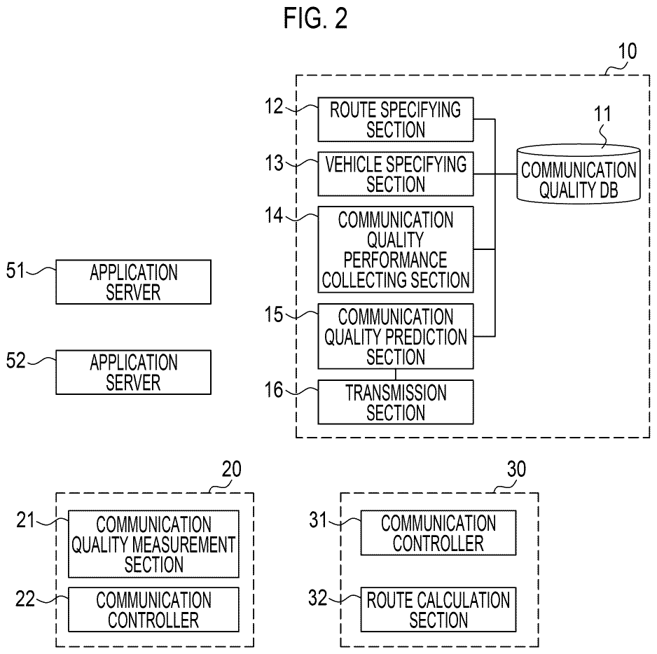

A modification will be described with reference to FIG. 2. In the modification, the application server 51 may be a content server that distributes data content to the vehicle, a data server that collects and accumulates data of the in-vehicle sensor, or the like. For example, the communication quality performance collecting section 14 of the prediction server 10 may include information instructing communication with the application server 51 via the application server 52 (here, any application server) in the link information not acquired. Then, the vehicle (for example, the vehicle 20) that receives the link information not acquired may measure the communication quality between the vehicle and the application server 52 by performing data communication with the application server 51 via the application server 52.

Aspects of the disclosure derived from the embodiments and the modifications described above will be described below.

A first aspect of the disclosure relates to a system including a database and a route specifying unit. The database stores communication performance data on a communication quality of a vehicle. The route specifying unit is configured to specify one route of which communication performance data within a predetermined period is not acquired. The system includes a vehicle specifying unit that specifies one vehicle including the one route in a scheduled travel route, and an acquisition unit that acquires one piece of communication performance data from the one vehicle traveling on the one route. In the above-described embodiment, the “communication quality database 11” corresponds to an example of the “database”, and the “route specifying section 12” corresponds to an example of the “route specifying unit”. In the above-described embodiment, the “vehicle specifying section 13” corresponds to an example of the “vehicle specifying unit”, and the “communication quality performance collecting section 14”corresponds to an example of the “acquisition unit”.

The system may further include a prediction unit configured to predict a communication quality of the one route based on the one piece of communication performance data. In the above-described embodiment, the “communication quality prediction section 15”corresponds to an example of the “prediction unit”.

In this case, the system may include transmission means for transmitting the predicted communication quality of the one route to another vehicle that travels on the one route in the future. In the above-described embodiment, the “transmission section 16” corresponds to an example of the “transmission unit”.

The present disclosure is not limited to the above-described embodiments, and can be appropriately modified within the scope not departing from the gist or the idea of the disclosure that can be read from the claims and an entirety of the specification, and a system with such a modification is also included in the technical scope of the present disclosure.

What is claimed is:

1. A system comprising:
a database in which communication performance data related to a communication quality of a vehicle is stored;
a route specifying unit configured to specify one route for which communication performance data within a predetermined period has not been acquired;
a vehicle specifying unit configured to specify one vehicle having a scheduled travel route that includes the one route; and
an acquisition unit configured to acquire one piece of communication performance data from the one vehicle that travels on the one route.

2. The system according to claim 1, further comprising a prediction unit configured to predict a communication quality of the one route based on the one piece of communication performance data.

3. The system according to claim 2, further comprising a transmission unit configured to transmit the predicted communication quality of the one route to another vehicle that travels on the one route in future.
